(19) United States
(12) Patent Application Publication
(10) Pub. No.: US 2009/0240552 A1
(43) Pub. Date: Sep. 24, 2009

(54) NETWORK-BASED INFORMATION TECHNOLOGY SOLUTION DEVELOPMENT AND MANAGEMENT SYSTEM AND METHOD

(75) Inventors: Hae-In Yang, Daejeon (KR); Won-Jin Yun, Daejeon (KR)

Correspondence Address: LUCAS & MERCANTI, LLP, 475 PARK AVENUE SOUTH, 15TH FLOOR, NEW YORK, NY, 10016, US

(73) Assignee: DMD CO., LTD., Daejeon (KR)

(21) Appl. No.: 12/297,997

(22) PCT Filed: Apr. 23, 2007
(86) PCT No.: PCT/KR07/01959

§ 371 Date: Oct. 21, 2008

(30) Foreign Application Priority Data
Apr. 21, 2006 (KR) 10-2006-0036273

(51) Int. Cl. G06Q 10/00; G06Q 30/00

(52) U.S. Cl. 705/9; 705/26; 705/7

(57) ABSTRACT

The invention relates to a network-based information technology solution development and management system and method. In the system and method according to an embodiment of the invention, when a customer requests the development of information technology solutions, a server computer provides information on analysts to a customer computer and allows the customer to contract with a specific analyst. Then, the analyst receives requirements for the development of the solutions from the customer to perform the planning of the solutions, the analysis of the requirements, and the design of the solutions, and then the server computer places an order for each unit program to developers. Subsequently, when the developers who have assigned the unit programs develop the unit programs and deliver the developed unit programs to the server computer, the server computer tests the unit programs to accept or return the unit programs. Then, the server computer provides information the account and payment of the developers having delivered the unit programs to a financial institution computer and allows the financial institution computer to pay development costs to the developers. Subsequently, the server computer performs an integrated test on the unit programs corresponding to each project that are delivered by the developers and delivers the tested unit programs to the customers.

### TECHNICAL FIELD

The present invention relates to a network-based information technology solution development and management system and method. More specifically, the invention relates to a network-based information technology solution development and management system and method capable of connecting customers not retaining high-quality developers to analysts and developers having developing abilities to develop various information technology solutions.

### BACKGROUND ART

In general, the Internet is an open network that uses a common protocol, called TCP/IP (transmission control protocol/Internet protocol), to enable users to freely access other computers through a computer network. The users can use various services, such as a short message service, an e-mail service, and a world wide web (WWW) service used to transmit multimedia information, by using a compression technique through the Internet.

With a rapid increase in the use of the Internet all over the world, the importance of the Internet is rapidly increasing as a strategic tool for improving the efficiency and productivity of the existing industries. In addition, the Internet continuously creates new business opportunities, and expands the area of business. Therefore, the number of enterprisers using the Internet is gradually increasing.

That is, the number of Internet business sites providing various contents, such as Internet advertisements, Internet broadcasting, online games, Internet newspaper/magazine, search services, portal services, and electronic commerce, is rapidly increasing.

Due to a rapid increase in the use of the Internet, the number of developers who develop various kinds of information technology solutions is significantly increasing. In addition, Internet sites that provide a service for making various information technology solutions for clients or companies not retaining solution developers or Internet sites that provide a service for connecting solution developers to the clients or the companies not hiring developers are being formed.

However, the Internet sites providing the service for making various information technology solutions or the service for connecting the developers to the enterprisers or the individuals do not have a system for completely examining the technical levels of developers, a project period, and contract conditions beforehand. In addition, since the developer should perform all processes such as from the planning of solutions to the execution of a unit program, it takes a lot of time to develop solutions. Further, since the quality of solutions depends on the ability of a developer, the enterprisers or the individuals requesting the solution making services may doubt the abilities of the developers, which makes it difficult to smoothly execute a solution making service.

Further, in the related art, since the development of solutions is not performed for every unit program, but is performed per units of project, it takes a lot of time to develop the programs. As a result, the developers are difficult to participate in the development of solutions using extra time, which makes it difficult to appropriately utilize high-quality human sources.

Furthermore, in the related art, the enterprisers deposit beforehand the total cost required to develop information technology solutions in the bank, or deposit half the total cost in the bank at the time of contract and deposit the other half in the bank when the solution is completely finished. Therefore, the enterprisers requesting the development of solutions need to pay high development costs at the beginning of a project. In addition, it is difficult for the enterprisers to systematically check the progress of solution development, which creates feeling of mistrust or dishonesty, such as diversion of funds and fraud, by the enterprisers.

Further, the developers are not provided with payment guarantee for solution development costs from the enterprisers requesting the development of solutions and the Internet sites providing a brokerage service. As a result, the developers may not perform work due to feeling insecure.

### DISCLOSURE OF INVENTION

### Technical Problem

The invention is designed to solve the above-mentioned problems, and an object of the invention to provide a network-based information technology solution development and management system and method capable of connecting customers not retaining developers to analysts and developers having developing abilities online to smoothly perform the development and management of various information technology solutions.

Another object of the invention is to provide a network-based information technology solution development and management system and method capable of providing human resources required to develop information technology solutions and a standardized development procedure to customers, allowing the customers to monitor the progress of solution development, and allowing analysts and developers to perform work anywhere and anytime.

Still another object of the invention is to provide a network-based information technology solution development and management system and method capable of allowing analysts to design each unit program when developing various information technology solutions requested by customers, assigning each unit program to developers such that the individual developers develop their own unit programs, and allowing an operator server to perform an integrated test on the unit programs developed by the developers and to deliver the test unit programs to the customers.

Yet another object of the invention is to provide a network-based information technology solution development and management system and method capable of allowing customers requesting the development of information technology solutions to sequentially deposit development costs corresponding to each unit program developing stage in the bank such that developers who are assigned the unit programs can develop the unit programs with confidence, and of retaining high-quality analysts and developers as members to provide high reliability to the customers.

### Technical Solution

According to an aspect of the invention, a network-based information technology solution development and management system includes: a customer computer that consults a project mentor about a project for developing information technology solutions, checks information on analysts who can participate in the project and contracts with a specific analyst, provides various requirements for the development of solutions to the analyst such that the analyst plans and develops the solutions, and deposits development funds to a financial institution in stages until the solutions are completely developed; an analyst computer that controls a process of making a plan to develop a specific information technology solution required by a customer, a process of analyzing requirements, a process of placing an order for each unit program, a delivery process, a process of asking to pay development costs, a process of performing an integrated test, and a process of delivering a job completion sheet and a product, and provides the customer computer with information on the solutions being currently developed at the request of the customer computer; a developer computer that checks information on various unit programs required to develop the solutions that are planned by the analyst, participates in the development of a desired unit program, and tests and delivers the developed unit program; a server computer that examines a plurality of analysts and developers who will plan the information technology solutions and develop the unit programs, registers the examined analysts and developers as members, extracts information on the analysts who can participate in the project on the basis of the content of the project registered by the project mentor and provides the extracted information to the customer computer, and integrally controls the input and output of data required for the process of making a plan to develop a specific information technology solution, the process of analyzing requirements, the process of placing an order for each unit program, the process of asking to pay development costs, a process of performing a test on each unit program, the delivery process, a process of performing an integrated test, and the process of delivering a job completion sheet and a product to/from the analyst computer and the developer computer; and a financial institution computer that receives funds corresponding to a predetermined number of states in the development of solutions from the customer, and transfers the funds deposited by the customer to the accounts of the analyst and the developer.

According to another aspect of the invention, a network-based information technology solution development and management method includes the steps of: allowing a server computer to examine analysts and developers on the basis of their careers and experiences of the analysts and the developers to grant the analysts and the developers qualifications; when a customer requests the development of an information technology solution, allowing the server computer to provide information on the analysts to a customer computer, thereby contracting with the customer, and allowing the contracted customer to deposit earnest money to a financial institution; when the customer provides requirements for the development of the solution to the analyst through the server computer, allowing the analyst to perform the planning of the solution, the analysis of the requirements, and the design of the solution, and allowing the server computer to place an order for each unit program according to the design performed by the analyst; allowing the server computer to test the unit programs developed by the developers to accept or return the developed unit programs, and to provide information on the account and payment of each of the developers having delivered the unit programs to a financial institution computer to pay the development costs to the developers; and allowing the server computer to perform an integrated test on the unit programs corresponding to each project that are developed by the developers in a system environment constructed according to a detailed design performed by the analyst, and when the integrated test is completed, allowing the server computer to deliver the tested unit programs.

### BRIEF DESCRIPTION OF THE DRAWINGS

FIG. 1 is a block diagram schematically illustrating the configuration of a network-based information technology solution development and management system according to an embodiment of the invention.

FIG. 2 is a block diagram illustrating the detailed configuration of a server computer shown in FIG. 1.

FIG. 3 is a flowchart illustrating a network-based information technology solution development and management method according to an embodiment of the invention.

FIGS. 4 to 8 are flowcharts illustrating subroutines shown in FIG. 3 in detail.

### REFERENCE NUMERALS

100: CUSTOMER COMPUTER
200: ANALYST COMPUTER
300: DEVELOPER COMPUTER
400: SERVER COMPUTER
410: PROJECT REGISTRATION UNIT
420: PROJECT MANAGEMENT UNIT
430: ORDER MANAGEMENT UNIT
440: DELIVERY MANAGEMENT UNIT
450: FUND MANAGEMENT UNIT
460: MEMBER MANAGEMENT UNIT
470: CONTROL UNIT
500: FINANCIAL INSTITUTION COMPUTER

### BEST MODE FOR CARRYING OUT THE INVENTION

Hereinafter, a network-based information technology solution management and development system and method according to an embodiment of the invention will be described with reference to the accompanying drawings.

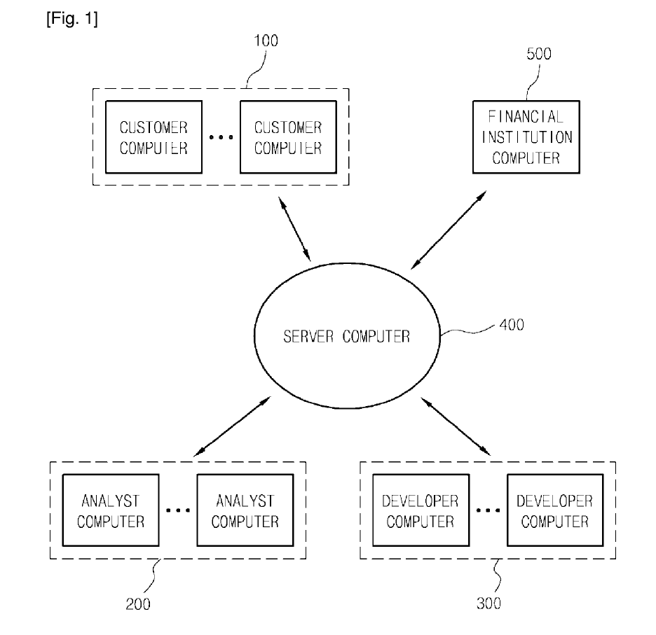

FIG. 1 is a block diagram schematically illustrating the configuration of a network-based information technology solution management and development system according to an embodiment of the invention.

As shown in FIG. 1, the network-based information technology solution management and development system includes a plurality of customer computers 100, a plurality of analyst computers 200, a plurality of developer computer 300, a server computer 400, and a financial institution computer 500.

The customer computers 100 are computer systems operated by individual persons or corporations that request solution development, and consult a project mentor of the server computer 400 to develop information technology solutions. The project mentor is a person who consults the persons or the corporations about projects and gives helps to them in the progress of the projects. That is, the project mentor serves as a consultant. Specifically, the project manager registers, for example, a project name, a project object, customer's requirements, a project delivery data, and a project forecast in a project registering unit 410 of the server computer, which will be described later, and enables an analyst to search projects and to help the analyst support the projects. When the content of a project to develop information technology solutions is registered in the server computer 400 by the project mentor, the customer computer 100 can utilize all of the systems supplied by the server computer 400 to advance a project. That is, the customer computer 100 checks information on analysts who can take part in a project, contracts with a specific analyst to develop solutions, provides the analyst with various requirements for solution development, advances the solution development, and deposits funds for each project step until the solution is completely developed according to an analyst's detailed design.

Each of the analyst computers 200 is an information technology analyzing unit, and serves as an analyst who plans projects, analyzes person's requirements, and performs the design. The server computer 400 examines the analysts to select one of the analysts. The selected analyst accesses the server computer 400 to search the project to be progressed by a customer, checks a current project schedule, checks the content of the project, and determines whether to participate in the project. Then, the analysts analyze and design customer's requirements, and register an expected order date and documents required to execute programs, such as a program list, a work order, a standard development definition, and a unit test scenario, on a list of items to be ordered, which will be described later, to the server computer. Each of the analysts receives pay according to the progress of solution development, freely selects a project suitable for his/her aptitude and schedule, completes the selected project, and periodically provides information on the progress of solutions to be currently developed to the customer computer 100 through the server computer 400.

The analyst computer 200 controls the plan of the development of a specific information technology solution requested by a customer computer, the analysis of requirements, the order of each unit program, delivery management, a request to pay development costs, an integral test, and the delivery of a completion report and products. In addition, each of the analyst computers provides the customer computer 100 information on the solutions being currently developed at the request of the customer computer 100 during the development of solutions.

When the developer computers 300 pass the test of the server computer 400, the developer computers 300 are given evaluation levels by the server computer 400 and then appropriate developers are selected. The developers retrieve the list of programs to be ordered on an order bulletin board, and access the server computer 400 when a specific program is ordered, select the specific program from the list of programs ordered, and receive an order for the selected program. In addition, each of the developer computers 300 confirms various unit program information items required to develop solutions that are planned by the analysts in the server computer 400, and receives a desired unit program and participates in the development of the program. Then, the developer computer delivers the developed unit program after the test of the unit program.

The developers, who are professional programmers, receive a job assignment on a free-lance basis, earning high salary in their specific fields. The developers who are free lancers can perform work anytime and anywhere. In addition, when the developers make an effort to continuously improve their technical abilities by taking additional educational courses provided by the server computer 400, such that the evaluation levels of the developers are increased, the developers can be offered higher wages for their effort.

The server computer 400 examines a large number of analysts and developers who plan information technology solutions and develop unit programs and registers them on a membership list. In addition, the server computer 400 extracts information of analysts who can take part in the development of information technology solutions on the basis of the content of a project registered by the project mentor after consulting with customers, and provides the information to the customer computer 100. Further, the server computer 400 integrally manages the input/output of data related to the plan of a specific information technology solution, the analysis of requirements, the ordering of each type of unit program, the test and delivery of each type of unit program, the payment of development costs, an integral test, and the delivery of a completion test and products to the analyst computers 200 and the developer computers 300.

Further, the server computer 400 can grade the analysts and developers, authorized members, and evaluate the results of the planning and management of specific solution development by the analysts and the results of the development of unit programs by the developers to adjust the levels of the analysts and developers.

Furthermore, when the customer computers 100 make various inquiries on the solutions being currently developed, the server computer 400 can receive response data of the inquiries from the analyst computers 200 or a designated answerer and provide the response data to the customer computers 100.

The financial computer 500 receives funds corresponding to a predetermined number of solution development steps from the customers, and transfers the funds deposited by the customers to analyst's and developer's accounts at the request of the server computer 400.

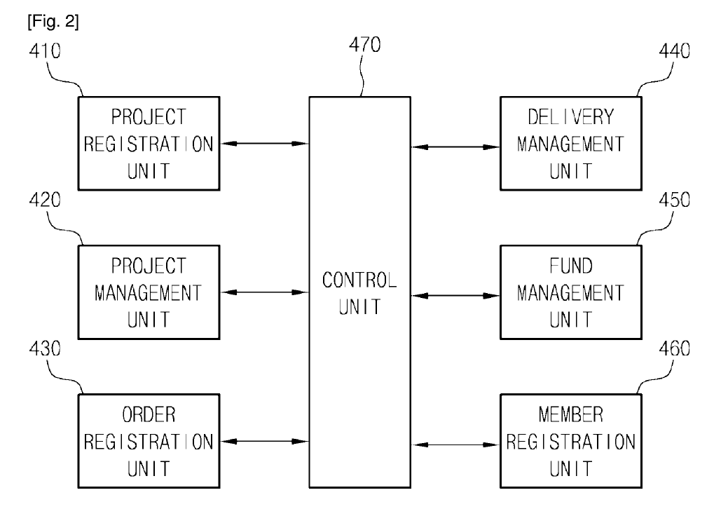

FIG. 2 is a block diagram illustrating the configuration of the server computer 400 shown in FIG. 1 in more detail.

As shown in FIG. 2, the server computer 400 includes a project registration unit 410, a project management unit 420, an order management unit 430, a delivery management unit 440, a fund management unit 450, a member management unit 460, and a control unit 470.

The project registration unit 410 registers the content of a project for developing information technology solutions that is determined after consulting with a customer on a bulletin board such that the analysts and the developers can view the contents of the project. Then, the project registration unit 410 checks whether the analysts who can perform the planning of the project, the analysis of requirements, and the design of the project registered by the project mentor can take part in the project, and provides information on the analysts who have intentions to participate in the project to the customer computer 100 such that the customer can have contact with the analysts most suitable for the project. Alternatively, the customers may directly check information on the analysts who can perform their projects and contact with a specific analyst.

The project management unit 420 supports a prescribed format and system environments required for the specific analyst contracting with the customer to perform the planning of solutions, the analysis of requirements, and the design of the solutions.

That is, the project management unit 420 enables the analyst to configure a basic format for all projects required to develop solutions (for example, schedule, the range of work, personnel organization, project public relations, a development plan, a test, monitoring, and all plans for control), to report a project schedule, development costs, the progress of the project, and the result of the project, and to provide information on delay in a schedule and expected excess costs, thereby smoothly advancing the project.

Further, the project management unit 420 creates detailed specifications of a program according to the planning of the project by the analyst and calculates the level and cost of the program to provide information on the total development cost of the project (for example, the level of the program, the number of programs, and hardware) to the fund management unit 450. In addition, the project management unit 420 provides a detailed job order sheet (including detailed specifications for every unit program, the configuration of a screen, and a test method) to the order management unit 430. Further, the project management unit 420 creates an exemplary program including detailed information on the development of programs, such as the writing of a scenario for an integral test for all projects, a common coding rule to programs in the project, system environment required for development, a rule for the design of the screen and uses the exemplary program as a standard model for developers. Furthermore, the project management unit 420 supports items required to construct a user manual for all projects, an operator manual therefor, and system environment capable of testing all the projects.

The order management unit 430 determines priority according to the detailed specifications written by the project management unit 420, and posts unit programs for every step together with the job order sheet on the order bulletin board such that the developers can select programs. That is, the order management unit 430 notifies the developers the time when programs are ordered, the type of programs to be ordered, and the number of programs for every level in the list of programs to be ordered through the order bulletin board such that the developers can instantly take part in the ordered programs. The order managing unit 430 automatically places an order for a program and sends e-mail or a short message to developers who request the transmission of e-mail or short messages to notify the developers that the program is ordered.

The order managing unit 430 extracts programs whose scheduled data has come from the list of programs to be ordered and collectively posts the extracted programs on the order bulletin board such that the individual developer can access the server computer 400 to receive an order for the program. The order management unit 430 operates a call center or provides an exemplary program to process various inquiries and remedies from the developers having received orders for programs in real time. In addition, when the developers are not punctual for the scheduled date of delivery, the order management unit 430 instantly sends an e-mail or short messages to the developers to notify the developers that the delivery data has lapsed, thereby controlling the process from the ordering of the project to the delivery of the project. When the ordered program is returned, the order management unit 430 takes disciplinary action against the corresponding developer.

In this case, each unit program whose order is placed by the order management unit 430 is provided to the developers together with basic information, such as a coding rule required to create programs, a system environment, and the design of a screen, and the costs of the ordered unit programs depend on the degree of difficulty and the type of programs.

The delivery management unit 440 provides an environment in which the source formed by the developers who have proposed for the unit program making job can be tested, and tests the unit programs delivered by the developers (for example, a text for checking program source codes and an execution test). Then, on the basis of the test result, the delivery management unit 440 notifies the developers that the delivered unit programs have acceptable quality or returns the delivered unit programs to the corresponding developers. In addition, the delivery management unit 440 performs an integral test for every project in a system environment constructed according to the detailed design established by the project management unit 420 and then approves the delivered unit programs if acceptable.

In this case, when the number of times the unit program is returned to the corresponding developer is larger than a predetermined value due to errors occurring in the unit program delivered by the developer, the developer management unit 440 lowers the level of the developer and takes disciplinary action against the developer in order to periodically manage the project schedule, thereby smoothly advancing the project.

The fund management unit 450 deposits the development costs corresponding to a predetermined number of steps paid by the customers in a financial institution according to the detailed design established by the project management unit 420 and verifies development costs and the liquidity of funds. When the developers completely deliver their unit programs to the delivery management unit 440, the fund management unit 450 provides information on the accounts of the analysts and the developers and payment information to the financial institution computer 500 to pay the development costs to the analysts and the developers. The fund management unit 450 allows the individual customer to inquire the development costs for each step of the project, which makes it possible to answer any questions about the use of funds and to control the progress of the project. In addition, the fund management unit 450 allows the analysts and the developers to inquire about information on development specifications and their wages up to the present and thus to use the information as reference data when they receive orders. Further, the fund management unit 450 settles, for example, a commission and consulting profits of the server at the end of every day or month.

When the analysts and the developers make an application to the site for membership, the member management unit 460 performs the identification of the applicants' real names, the examination of applicants' careers, interviews, and tests to classify basic information on each of the analysts and the developers, information on project careers, and information on the experience levels according to the job and technical fields, and reflects evaluation data based on the execution results of projects determined by the delivery management unit 440 to the levels of the developers. In addition, the member management unit 460 provides on-line spaces for Internet cafes or groups most suitable for their characteristics where members can share data, thereby improving the convenience of the members.

The control unit 470 controls the connection between the server computer 400, and the customer computers 100, the analyst computers 200, the developer computers 300 and the financial institution computer 500 over a communication network, such as the Internet, and the input/output of various data related to the development of projects.

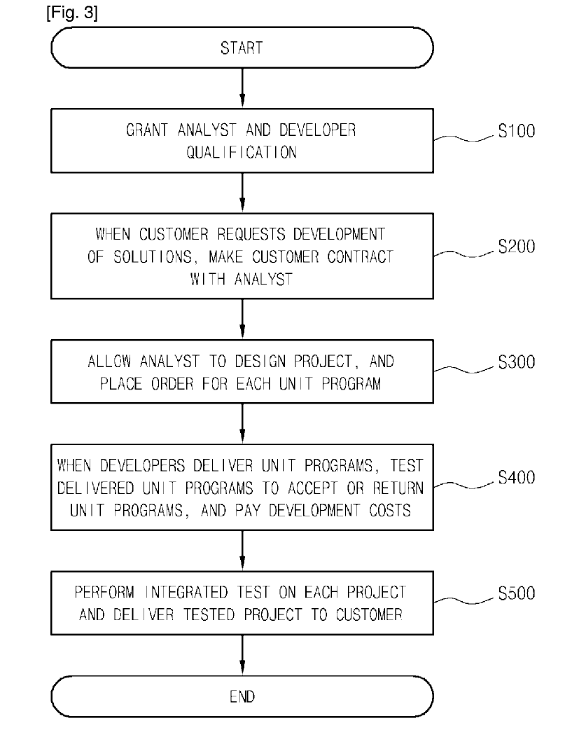

Next, a network-based information technology solution development/management method according to an embodiment of the invention will be described in detail with reference to FIGS. 3 to 8.

FIGS. 3 to 8 are flowcharts illustrating the network-based information technology solution development/management method according to the embodiment of the invention.

First, the server computer 400 examines the analysts' careers on the basis of the analysts' careers and experiences to grant the analysts qualification and also tests the levels of developments to grant the developers certification (S100).

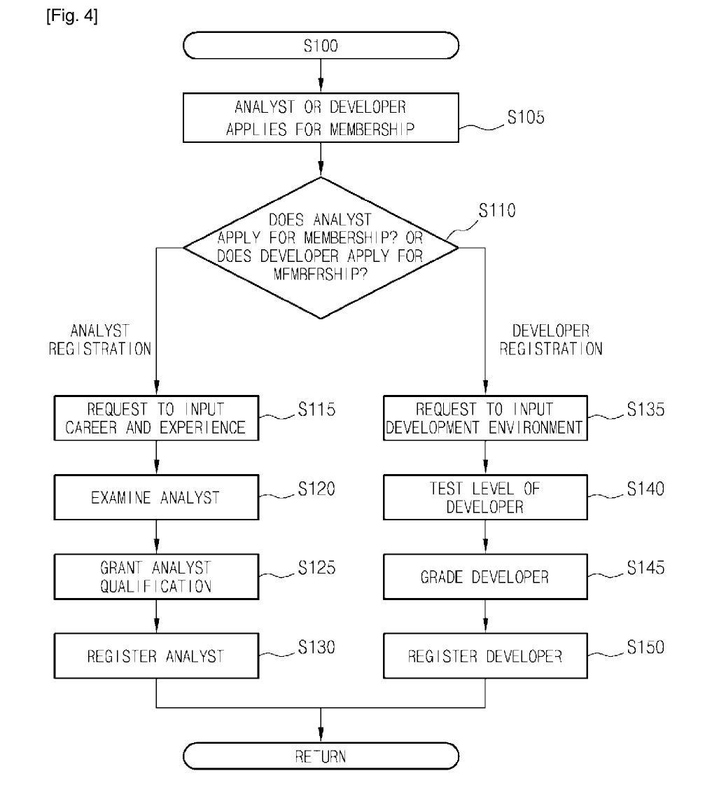

The above process will be described in more detail with reference to FIG. 4. As shown in FIG. 4, when the analyst computer 200 or the development computer 300 accesses the server computer 400, the server computer 400 checks whether the analyst computer 200 or the development computer 300 applies for admission to the server (S105), and determines whether an analyst applies for admission to the server or a developer applies for admission to the server (S110). That is, the server computer 400 determines whether the analyst or the developer whose real name is identified and who agrees with a membership policy apply for admission to the server.

As the result of the determination, when it is determined that the analyst applies for admission to the server, the server computer 400 requests the corresponding analyst computer 200 to transmit history information and career information (S115). Then, the server computer 400 performs a simple test on the analyst and checks on the career of the analyst on the basis of the history information and the career information transmitted from the analyst computer 200 (S120).

The server computer 400 sends the analyst computer 200 a message indicating that the analyst passes the career examination (for example, sends e-mail or a short message) (S125), and registers information on the approved analyst to the member management unit 460 in which the analyst is given an opportunity to participate in the projects requested by the customers (S130).

When it is determined in step S110 that the developer applies admission to the server, the server computer 400 requests the corresponding developer computer 300 to input developer's development environment (S135), and performs tests to determine the level of the developer who has input his/her development environment (S140). In the test for determining the level of the developer, the developer selects his/her own field, such as a language, an operating system, or the design and takes a test for the selected field. The server computer 400 gives the developer a basic level on-line. However, the developer should take a level test off-line in order to obtain a higher level. The server computer 400 allows an operator side to give the developers an opportunity to finish education.

The server computer 400 determines the levels of the developers on the basis of the results of interviews, tests, and the level of education (S145), and registers information on the developers whose levels have been determined on the member management unit 460 to give the developers an opportunity to participate in the bid and development of unit programs (S150).

When the customer requests the development of information technology solutions, the server computer 400 having both the analysts and the developers as members in step S100 provides information on the analysts to the customer computer 100 to allow the customer to contract with a specific analyst. In addition, the server computer 400 requests the customer to deposit money to the financial institution to start the project and provides requirements for solution development to the analyst (S200).

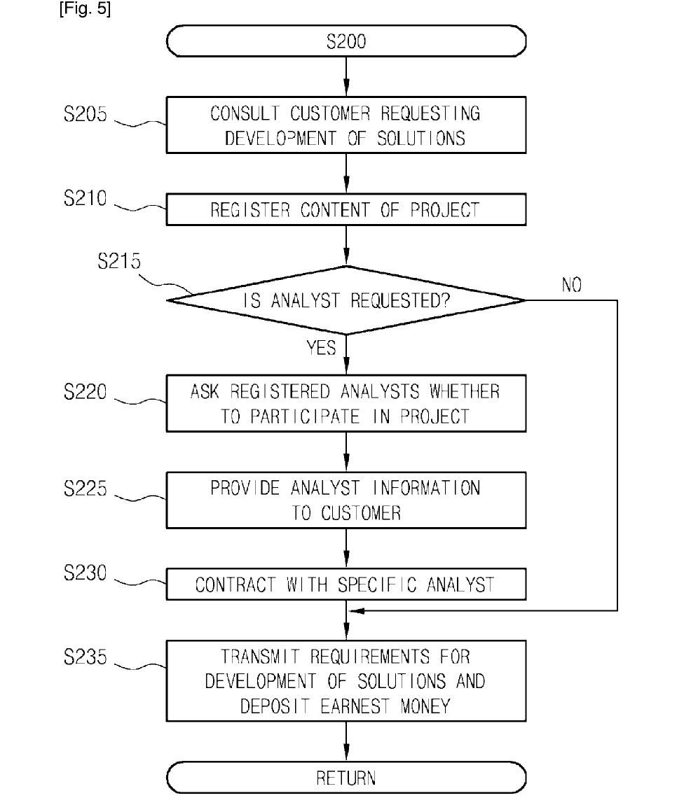

The above process will be described in detail with reference to FIG. 5. As shown in FIG. 5, a project mentor consults a customer having an information technology solution development plan through the server computer 400 to determine the start point of the project according to the state of the customer. Then, the project manager checks customer's requirements and manages the project such that the project progresses smoothly until the project is completed (S205), and registers project specifications requested by the customer on the project management unit 420 (S210).

Subsequently, the server computer 400 determines whether the customer computer 100 requests an analyst required for the planning and design of the project (S215). When the analyst is requested, the server computer 400 asks the analysts registered on the member management unit 460 whether to participate in the project (S220), and provides information on the analysts having the intent to participate in the project to the customer computer 100 (S225).

The customer having received the information on the analysts from the server computer 400 contracts with a specific analyst suitable for the project about items required to execute the project, such as pay and schedule (in this case, the server computer 400 makes a predetermined commission contract with the customer) (S230), and transmits requirements for the development of solutions to the corresponding analyst. Then, the customer deposits money to the financial institution to start the project for every step before the project starts (S235).

Subsequently, the customer receives the result and progress of solution development according to the detailed design by the analyst (that is, information on the delay of schedule, excess costs, and the lowering of quality) from the analyst, and deposits development costs to the financial institution for every step until the solutions are completely developed at the request of the analyst.

When the money deposited to the financial institution for every step by the customer is smaller than the actual stated development costs for every step, the project does not progress to the next step. Therefore, when estimated development costs are changed during planning or design, the analyst directly notifies the customer that the estimated development costs are changed, and checks estimated development costs in the next step and the balance at the financial institution. When the balance at the financial institution is smaller than the estimated development costs, the analyst notifies it to the customer.

The analyst having received customer's requirements for solution development in step S200 performs the planning of solution development, the analysis of requirements, and the design, and the computer 400 places an order for each unit program according to the design performed by the analyst (S300).

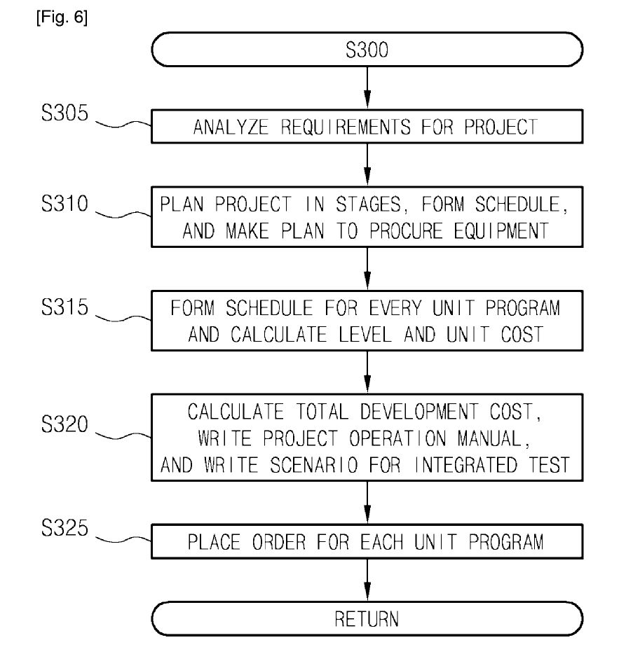

The above process will be described in detail with reference to FIG. 6. As shown in FIG. 6, the analyst contracting with the customer performs work according to a standard procedure, regulations, and guidelines provided by the server computer 400. First, the analyst analyzes customer's requirements for solution development (S305), and plans the project for every step on the basis of the analyzed requirements to schedule the entire project. Then, the analyst determines the range of work to create a work breakdown structure (WBS), and makes a plan to procure equipment for constructing online and test environments (S310). The analyst also makes a plan to monitor dangerous factors in the entire project.

The analyst making a project plan creates a common rule and an exemplary program applied to develop the program by the developer in order to perform the analysis of requirements and the design, and makes a plan for every unit program. Then, the analyst makes a job order sheet (for example, detailed specifications, the configuration of a screen, and a test method), and calculates the cost and level of each unit program (S315).

Then, the analyst calculates the total development cost required to develop the project including a hardware cost on the basis of the cost and level of each unit program, and makes an operating manual for the entire project. In addition, the analyst constructs a system environment in which the entire project can be tested and an integrated scenario for an integrated test (S320).

The server computer 400 registers the job order sheet together with each unit program according to the planning of the project, the analysis of requirements, and the design of the project performed by the analyst (for example, the server computer 400 registers them on a bulletin board through the order management unit 430) and places an order (S325). In this case, the ordered unit programs are provided together with basic information, such as information on a system environment, the design of a screen, and a coding rule required to make a program, and the costs of the ordered unit programs depend on the degree of difficulty and the type of programs.

When the unit programs are ordered according to the planning of the project, the analysis of requirements, and the design of the project performed by the analysts in step S300, the server computer 400 tests the unit programs developed by the developers having received the unit program making orders and accepts or returns the unit programs. Then, the server computer 400 provides information on the accounts and payment of the developers having delivered the unit programs to the financial institution computer 500 to control the payment of developing costs to the developers (S400).

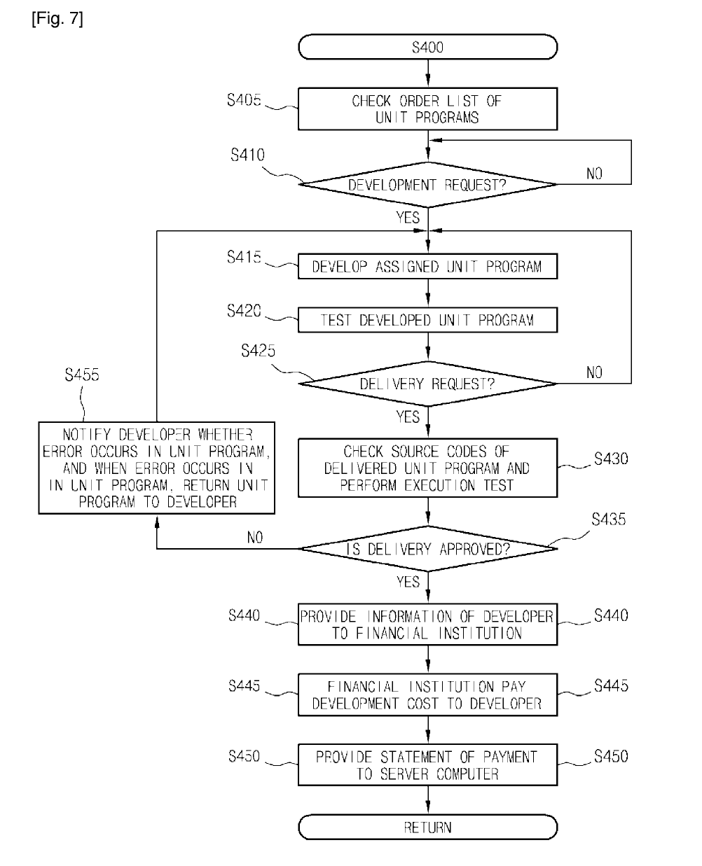

The above process will be described in detail with reference to FIG. 7. The developers view a list of unit programs registered on the server computer 400, and check whether the corresponding unit programs are ordered for them (S405). When the developers have received the program developing orders from the server computer 400, the developers can inquire the specifications and payment of their programs at any time.

The server computer 400 determines whether the developer having checked the list of unit programs requests the development of a specific unit program (S410). When the developer requests the development of a specific unit program, the server computer 400 provides information on the unit program selected by the developer such that the developer can develop the unit program (S415). In this case, the developer uses his/her own computer to develop the unit program with reference to a job order sheet, a common rule, and an exemplary program of the unit program at a place where the developer wants to work.

Meanwhile, when receiving inquiries about the unit programs from the developers having received the unit program making orders and developed the unit programs, the server computer 400 receives response data to the inquiries from the analyst computers 200 or a designated respondent and provides the response data to the corresponding developer computer 300.

When the ordered unit program is completely developed, the developer accesses a test environment constructed in the server computer 400 and performs compile the developed unit program to test the unit program (S420). That is, the developer asks the server computer 400 whether the developed unit program is correctly coded.

Then, the server computer 400 determines whether the developer computer 300 applies for the delivery of the unit program (S425). When the unit program is delivered, the server computer 400 checks source codes of the delivered unit program and performs an execution test on the unit program (S430).

The server computer 400 determines whether to accept or return the unit programs on the basis of the results of the execution tests for the unit programs delivered by the developers (S435). When the delivery of the unit program is approved on the basis of the test result of the delivered unit program, the server computer 400 provides information on the account and payment of the corresponding developer to the financial institution computer 500 (S440). In this case, the server computer 400 notifies the corresponding developer that the delivery of the unit program is approved.

Then, the financial institution computer 500 pays the development cost to the developer on the basis of the information on the account and payment of the developer input from the server computer 400 (S445), and provides a statement of payment to the server computer 400 (S450).

However, if the test result is not acceptable due to errors occurring in the delivered unit program and the delivery of the unit program is not approved in step S435, the server computer 400 returns the unit program to the developer computer 300 and requests the developer computer 300 to correct the unit program (S455). In this case, when the number of times the unit program developed by the developer is returned is larger than a predetermined value, the server computer 400 can lower the level of the developer.

After performing the process of accepting the unit programs developed by the developers and the payment process, the server computer 400 performs an integrated test on the unit program corresponding to each project that is developed by the developers in a system environment constructed according to the detailed design performed by the analyst. When, the integrated test is completed, the computer server 400 delivers the corresponding solution to the customer, and ends the project (S500).

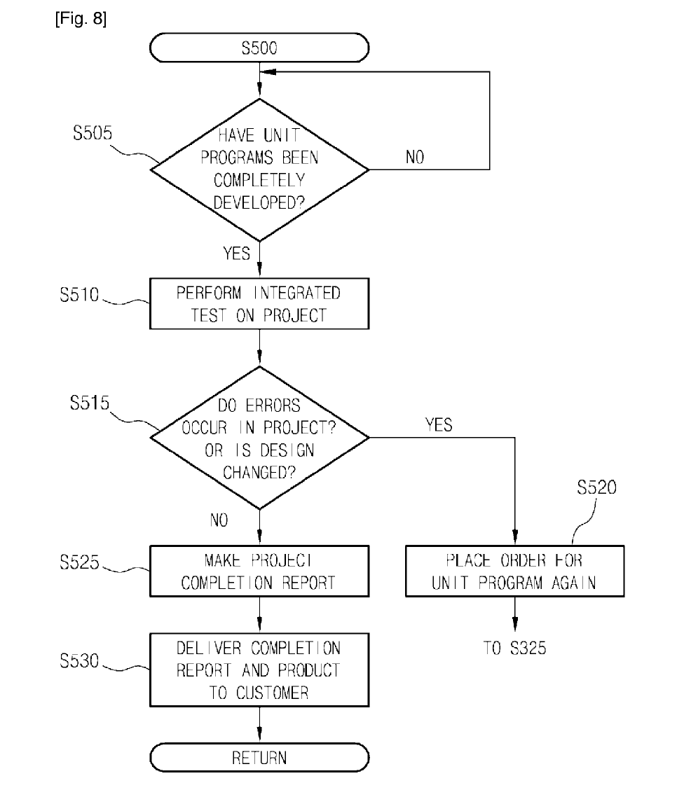

The above process will be described in detail with reference to FIG. 8. As shown in FIG. 8, the server computer 400 determines whether all the unit programs ordered according to the detailed design by the analyst are completely developed (S505).

When it is determined that all of the unit programs are completely developed, the server computer performs an integrated test on the unit programs corresponding to each project that are developed by the developers in a system environment constructed according to the detailed design performed by the analyst (S510).

Then, the server computer 400 determines whether errors occur in the integrated test for each project or the design is changed (S515).

As the result of the determination, when errors occur in the integrated test or the design is changed, the server computer 400 repeatedly performs steps subsequent to step S325 to place an order for the unit programs having errors or the changed design again according to the detailed design performed by the analyst, thereby completing the project (S520).

However, when it is determined in step S515 that no error occurs and the design is not changed, the server computer 400 requests the analyst to make a project completion report (S525), delivers a product and the project completion report made by the analyst to the customer, and ends the project (S530). In this case, the preservation period of information on the ended project can be determined by consulting with the customer.

Although the exemplary embodiment of the invention has been described above, the invention is not limited thereto. For example, it will be apparent those skilled in the art that various modifications and changes of the invention can be made without departing from the scope and spirit of the invention. Therefore, it should be understood that the above-described embodiment is not limitative, but illustrative in all aspects.

### INDUSTRIAL APPLICABILITY

As described above, according to the network-based information technology solution management/development system and method according to an embodiment of the invention, a server operator hires analysts who plan and design information technology solutions and developers who develop unit programs, and acts as a go-between customers not having sufficient man power to develop information technology solutions and the analysts and developers to help the customers industrialize their ideas, that is, to develop stable solutions through the overall process from planning to the completion of development. In addition, the server operator provides a system for managing the quality of developed solutions to enable the customers to develop high-quality solutions at low development costs and in a short time using high-quality human resources, a standardized developing method, and a standardized developing procedure. Further, according to the above-described embodiment, it is possible to perform monitoring in real time to remove dangerous factors, such as delay in schedule and excess cost, to clearly check the fund's operation, and to prepare funds required for the next process beforehand.

Further, the server operator provides a safety device for preventing unit program developers from viewing the contents of all of the solutions, and deposits funds to a financial institution in stages as solution development advances and manages the funds, which makes it possible to remove dangerous factors, such as the misuse of funds and fraud. The analysts perform planning, the analysis of requirements, the design, the management of orders, and the management of delivery, and the developers develop unit programs through a division of labor, which makes it possible to improve the efficiency of work and to provide a high-quality information technology solution to the customers.

Furthermore, it is possible to provide a new occupation to the information technology industry, which is a 3D industry, and also provide environment in which the analysts and the developers can work on a free-lance basis anywhere and any time, earning a high salary (that is, an environment for workers working at home). In addition, the analysts and the developers can continuously on projects applicable to their careers and fields while being recognized as excellent workers, and the development costs deposited in stages to the financial institution with the progress of solution development make it possible to remove fear that the analysts or the developers are not paid their salaries. As a result, the analysts or the developers can concentrate on their work with confidence, which makes it possible to improve the efficiency of work.

1. A network-based information technology solution development and management system comprising:
a customer computer that consults a project mentor about a project for developing information technology solutions, checks information on analysts who can participate in the project and contracts with a specific analyst, provides various requirements for the development of solutions to the analyst such that the analyst plans and develops the solutions, and deposits development funds to a financial institution in stages until the solutions are completely developed;
an analyst computer that controls a process of making a plan to develop a specific information technology solution required by a customer, a process of analyzing requirements, a process of placing an order for each unit program, a delivery process, a process of asking to pay development costs, a process of performing an integrated test, and a process of delivering a job completion sheet and a product, and provides the customer computer with information on the solutions being currently developed at the request of the customer computer;
a developer computer that checks information on various unit programs required to develop the solutions that are planned by the analyst, participates in the development of a desired unit program, and tests and delivers the developed unit program;
a server computer that examines a plurality of analysts and developers who will plan the information technology solutions and develop the unit programs, registers the examined analysts and developers as members, extracts information on the analysts who can participate in the project on the basis of the content of the project registered by the project mentor and provides the extracted information to the customer computer, and integrally controls the input and output of data required for the process of making a plan to develop a specific information technology solution, the process of analyzing requirements, the process of placing an order for each unit program, the process of asking to pay development costs, a process of performing a test on each unit program, the delivery process, a process of performing an integrated test, and the process of delivering a job completion sheet and a product to/from the analyst computer and the developer computer; and
a financial institution computer that receives funds corresponding to a pre-determined number of states in the development of solutions from the customer, and transfers the funds deposited by the customer to the accounts of the analyst and the developer.

2. The network-based information technology solution development and management system according to claim 1,
wherein the server computer includes:
a project registration unit that registers the content of the project for developing the information technology solution input by the project mentor on a bulletin board, selects an analyst who can perform the planning of the registered project, the analysis of requirement, and the design of the project, and provides information on the selected analyst to the customer computer;
a project management unit that supports a system environment and a pre-determined form required for the analyst contracting with the customer to perform the planning of solution development, the analysis of requirements, and the design of the solution;
an order management unit that determines priority according to a detailed design performed by the project management unit, posts the unit programs corresponding to each stage on an order bulletin board, answers various inquiries from the developers who receives orders for the unit programs, and takes disciplinary measure against the developers whose unit programs are returned;
a delivery management unit that provides a system environment in which the developers who receive orders for the unit programs can test sources, when the developers deliver the tested unit programs, tests the delivered unit programs to accept or return the delivered unit programs, performs an integrated test on the unit programs corresponding to each project in the system environment that is constructed according to the detailed design performed by the project management unit, and finally delivers the project.
a fund management unit that allows the customer to deposit development costs in stages according to the detailed design performed by the project management unit, when each of the developers completely delivers the unit program through the delivery management unit, provides information on the account and payment of each of the analysts and the developers to the financial institution computer to pay the development costs to the analysts and the developers, and stores information on the development costs corresponding to each project and information on money paid to each of the analysts and the developers such that the analysts and the developers inquire information on the money;
a member management unit that manages basic information, project history information, and level information of each of the analysts and the developers who are registered as members according to the career and field of each of the analysts and the developers, and reflects evaluation data based on the project execution results determined by the delivery management unit; and
a control unit that controls communication and data transmission among the customer computer, the analyst computer, and the developer computer, and controls the operation of each of the units.

3. The network-based information technology solution development and management system according to claim 2,
wherein each of the unit programs is ordered together with basic information, such as a screen design, a system environment, and a coding rule required to make the program by the order management unit, and the unit costs of the unit programs depend on the degree of difficulty and the type of unit programs.

4. The network-based information technology solution development and management system according to claim 2,
wherein, when the number of times the unit program delivered by the developer is returned is larger than a predetermined value on the basis of the result checked by the delivery management unit, the level of the developer is lowered.

5. The network-based information technology solution development and management system according to claim 1,
wherein the analyst computer periodically provides information on the progress of the solution being currently developed to the customer computer through the server computer.

6. The network-based information technology solution development and management system according to claim 1,
wherein, when the customer computer transmits various inquiries about the solution being currently developed to the server computer, the server computer receives response data to the inquiries from the analyst computer or a designated answerer and provides the response data to the customer computer.

7. The network-based information technology solution development and management system according to claim 1,
wherein the server computer gives levels to the analysts and the developers registered as members, and evaluates the planning and management results of specific solutions by the analysts and the results of the unit programs developed by the developers to grade the levels of the analysts and the developers.

8. A network-based information technology solution development and management method comprising the steps of:
(a) allowing a server computer to examine analysts and developers on the basis of the careers and experiences of the analysts and the developers to grant the analysts and the developers qualifications;
(b) when a customer requests the development of an information technology solution, allowing the server computer to provide information on the analysts to a customer computer, thereby contracting with the customer, and allowing the contracted customer to deposit earnest money to a financial institution;
(c) when the customer provides requirements for the development of the solution to the analyst through the server computer, allowing the analyst to perform the planning of the solution, the analysis of the requirements, and the design of the solution, and allowing the server computer to place an order for each unit program according to the design performed by the analyst;
(d) allowing the server computer to test the unit programs developed by the developers to accept or return the developed unit programs, and to provide information on the account and payment of each of the developers having delivered the unit programs to a financial institution computer to pay the development costs to the developers; and
(e) allowing the server computer to perform an integrated test on the unit programs corresponding to each project that are developed by the developers in a system environment constructed according to a detailed design performed by the analyst, and when the integrated test is completed, allowing the server computer to deliver the tested unit programs.

9. The network-based information technology solution development and management method according to claim 8,
wherein the step (a) includes the steps of:
(a-1) allowing the server computer to determine whether the analysts or developers whose real names are identified and who agree with a membership policy apply for membership;
(a-2) when the analysts apply for membership, allowing the server computer to request a corresponding analyst computer to input experience information and career information;
(a-3) allowing the server computer to examine the analyst on the basis of the experience information and the career information input from the analyst computer and to notify the analyst computer whether the analyst is qualified as a member on the basis of the result of the examination;
(a-4) allowing the server computer to register information about the analyst on a member management unit;
(a-5) when the developers apply for membership, allowing the server computer to request a corresponding developer computer to input a development environment;
(a-6) allowing the server computer to test the developer who inputs the development environment to grade the level of the developer; and
(a-7) allowing the server computer to register information of the developer whose level is determined on the member management unit.

10. The network-based information technology solution development and management method according to claim 8,
wherein the step (b) includes the steps of:
(b-1) allowing the server computer to consult a customer who has a plan to develop an information technology solution and to register the content of a project requested by the customer;
(b-2) allowing the server computer to determine whether the customer computer requests to select an analyst who plans and designs the solution;
(b-3) when the request to select the analyst is made, allowing the server computer to select analyst information and to provide the selected analyst information to the customer computer; and
(b-4) when the customer checks the analyst information provided from the server computer, contracts with a specific analyst, and transmits requirements for the development of the solution to the analyst, allowing the customer to deposit the earnest money to the financial institution.

11. The network-based information technology solution development and management method according to claim 10,
wherein, after the step (b-4), the customer receives information on the progress of the solution being developed according to the detailed design performed by the analyst, and
the customer deposits development costs in stages to the financial institution until the solution is completely developed at the request of the analyst.

12. The network-based information technology solution development and management method according to claim 8,
wherein the step (c) includes the steps of:
(c-1) allowing the analyst to analyze the requirements according to the solution of the customer registered in the server computer;
(c-2) planning the project according to each stage on the basis of the requirements analyzed by the analyst, form a schedule for the project, and making a plan to procure online equipment and test equipment;
(c-3) allowing the analyst making a plan for the project to form a schedule for each unit program in order to perform the analysis of requirements and the design of the solution, and to calculate the level and the unit cost of the program;
(c-4) allowing the analyst to calculate the total development cost required to develop the project, including the cost of hardware, to form a project operation manual, and to write an integrated scenario for performing an integrated test on the project; and
(c-5) allowing the server computer to register each unit program together with a job order sheet according to the planning of the project, the analysis of requirements, and the design of the project performed by the analyst and to place an order for the project.

13. The network-based information technology solution development and management method according to claim 12,
wherein, in the step (c-5), each unit program is provided together with a screen design, a system environment, and a coding rule required to make the program, and the unit costs of the unit programs depend on the degree of difficulty and the kind of unit programs.

14. The network-based information technology solution development and management method according to claim 8,
wherein the step (d) includes the steps of:
(d-1) allowing the developers to check the unit programs registered in the server computer and to receive orders for specific unit programs to develop the unit program;
(d-2) when the unit programs assigned to the developers are completely developed, allowing the developers to access a test environment constructed in the server computer and to test the unit programs through compiles of the unit program;
(d-3) when the developer computer delivers the unit program, allowing the server computer to check source codes of the delivered unit program and perform an execution test on the unit program;
(d-4) when the delivered unit program passes the test, allowing the server computer to provide information on the account and payment of the developer to the financial institution computer in order to pay the development cost to the developer;
(d-5) allowing the financial institution computer to pay the development cost to the developer on the basis of the information on the account and payment of the developer provided from the server computer and to provide a statement of payment to the server computer; and
(d-6) when the delivered unit program does not pass the test due to errors, allowing the server computer to return the unit program to the developer computer and to request to correct the unit program.

15. The network-based information technology solution development and management method according to claim 14,
wherein, when the server computer receives various inquiries from the developers who are assigned the unit program and develop the unit program in the step (d-1), the server computer receives response data to the inquiries from the analyst computer or a designated answerer and provides the response data to the developer computers.

16. The network-based information technology solution development and management method according to claim 14,
wherein, when the number of times the unit program delivered by the developer is returned is larger than a predetermined value, the server computer lowers the level of the developer.

17. The network-based information technology solution development and management method according to claim 8,
wherein the step (e) includes the steps of:
(e-1) allowing the server computer to determine whether all of the unit programs assigned according to the detailed design performed by the analyst are completely developed;
(e-2) when all of the unit programs are completely developed, allowing the server computer to perform an integrated test on the unit programs corresponding to each project that are developed by the developer in a system environment constructed according to the detailed design performed by the analyst;
(e-3) allowing the server computer to determine whether errors occur in the unit programs during the integrated test for each project or whether the design is changed;
(e-4) when the errors occur in the unit programs or the design is changed, allowing the server computer to place orders for the unit programs which have the errors and whose designs are changed again according to the detailed design performed by the analyst; and
(e-5) when no error occurs in the unit programs or the design is not changed, allowing the server computer to deliver a product and a job completion report made by the analyst to the customer.
